(19) United States
(12) Patent Application Publication
(10) Pub. No.: US 2014/0325574 A1
(43) Pub. Date: Oct. 30, 2014

(54) PERCEPTORS AND METHODS PERTAINING THERETO

(71) Applicant: KOOZOO, INC., San Francisco, CA (US)

(72) Inventors: Jonathan D. Mendelson, San Carlos, CA (US); Ognjen Sami, Beograd (RS); Jonathan Cobb, Piedmont, CA (US)

(73) Assignee: Koozoo, Inc., San Francisco, CA (US)

(21) Appl. No.: 13/874,122

(22) Filed: Apr. 30, 2013

(51) Int. Cl. H04N 21/4223; H04N 21/234

(52) U.S. Cl. CPC H04N 21/4223; H04N 21/23418
USPC 725/109

(57) ABSTRACT

A distributed system in a data network for processing real time data streams from multiple data sources includes perceptors accessible over the data network each being configured to perform a specific task. Each perceptor receives one or more of the real time data streams and provides an output data stream indicative of the results of performing the specific task. In addition, the distributed system includes also multiple applications accessible over the data network. Each application is configured to receive one or more of the output data streams of the perceptors and each application is configured to provide a response based on analyzing the received output data streams of the perceptors. The distributed system also includes a stream server accessible over the data network. The stream server receives the real time data streams and is configured to provide any of the received real time data streams to any of the perceptors.

### BACKGROUND OF THE INVENTION

1. Field of the Invention

The present invention relates to processing real time data. In particular, the present invention relates to processing real data received from a large network of sensors, such as live video data provided by a network of video cameras placed at numerous locations.

2. Discussion of the Related Art

Publicly accessible wide area data networks, such as the Internet, allow connecting together a very large number of real time data sources or sensors without regard to the actual physical or geographical locations of these real time data sources or sensors. For example, it has recently become available a network that allows a user to connect live video cameras into the network and to view any of the live video streams from cameras of other users in the network. One example of such a network is described in U.S. patent application, Ser. No. 13/421,053, entitled “Method and System for a Network of Multiple On-line Video Sources,” filed on Mar. 15, 2012.

In another example, some mobile devices (e.g., “smart” telephones) are known to update their real time geographical locations to servers on a network, some even periodically, to allow a server in a communication network to track the individual movements of the mobile devices (and hence their users) and to push information of local relevance to the users based on the reported geographical locations.

At this time, these networks merely allow their users to access real time data sources individually or in small groups, or allow a server to provide customized service to individual users. Thus, the significant value in the available real time data streams remains unexploited or under-exploited. The real time data streams from a large number of sensors of known positions can provide significant information regarding the environments in which these sensors are deployed. For example, live video data streams from multiple cameras within a city block can indicate the different levels of human activities at different times of the day. Such information may be of significant commercial or administrative value to business or law enforcement, for example. However, effective tools designed to harvest the significant value in the real time data stream are scarce, if not non-existent.

### SUMMARY

According to one embodiment of the present invention, a distributed system in a data network for processing real time data streams from multiple data sources includes perceptors accessible over the data network. A perceptor is a data processing program or device configured to perform a specific task on one or more real time data streams it receives and which provides an output data stream indicative of the results of performing the specific task. A perceptor may also include one or more structured visual inspections of data streams by human participants. Results from all perceptors may be processed, stored or archived in appropriate databases in real time. In addition, the distributed system includes also multiple applications accessible over the data network. Each application is configured to receive one or more of the output data streams of the perceptors and each application is configured to provide a response based on analyzing the received output data streams of the perceptors. The distributed system also includes a stream server accessible over the data network. The stream server receives the real time data streams and is configured to provide any of the received real time data streams to any of the perceptors.

In one embodiment, the distributed system further includes a data collection server accessible over the data network, the data collection server being configured to provide the output data stream of any of the perceptors to any of the applications.

In one embodiment, a selected one of the output data streams of the perceptors is provided to the stream server as one of the real time data streams received into the distributed system.

In one embodiment, the distributed system further includes a web server accessible over data network by one or more clients each using a corresponding web interface, the web server receiving one or more of the real time data streams and providing each client one or more of the real time data streams. In that embodiment, each client is associated with an application that communicates with one or more of the perceptors or one or more of the applications using an application program interface. One of the clients may receive an input from a human user that, based on the input, causes a feedback signal to be sent to one of the perceptors.

In one embodiment, the data sources include video cameras providing live video streams. In that embodiment, one or more of the perceptors apply to the received video streams computer vision techniques, so as to recognize a specific object captured in the frames of the video streams. Alternatively, one or more of the perceptors apply to one or more of the received video streams motion detection techniques, so as to recognize motion of one or more objects captured in the frames of the video streams. Still alternatively, one or more of the perceptors apply to the received real time data streams speech recognition techniques, the received real time data streams include sound captured by a microphone, so as to recognize a verbal command.

In one embodiment, one or more of the perceptors apply to the received real time data streams pattern recognition techniques, the real time data streams including still images, so as to recognize an embedded code in one of the still images. Alternatively, one or more of the perceptors apply to the received real time data streams character recognition techniques, so as to recognize characters embedded in one of the still images.

In other embodiments, the perceptors compute statistical quantities from the received real time data streams.

The response from an application may include sending an electronic message to inform a user of an exception condition, or causing a corrective action to be performed at one or more of the data sources.

The present invention is better understood upon consideration of the detailed description below in conjunction with the accompanying drawings.

### BRIEF DESCRIPTION OF THE DRAWINGS

FIG. 1 shows system 100, which includes multiple real time data sources 101-1, 101-2, . . . , 101-n that may be dynamically programmed to be connected to provide data streams to perceptors 102-1, 102-2, . . . , 102-m for processing, in accordance with one embodiment of the present invention.

### DETAILED DESCRIPTION OF THE PREFERRED EMBODIMENTS

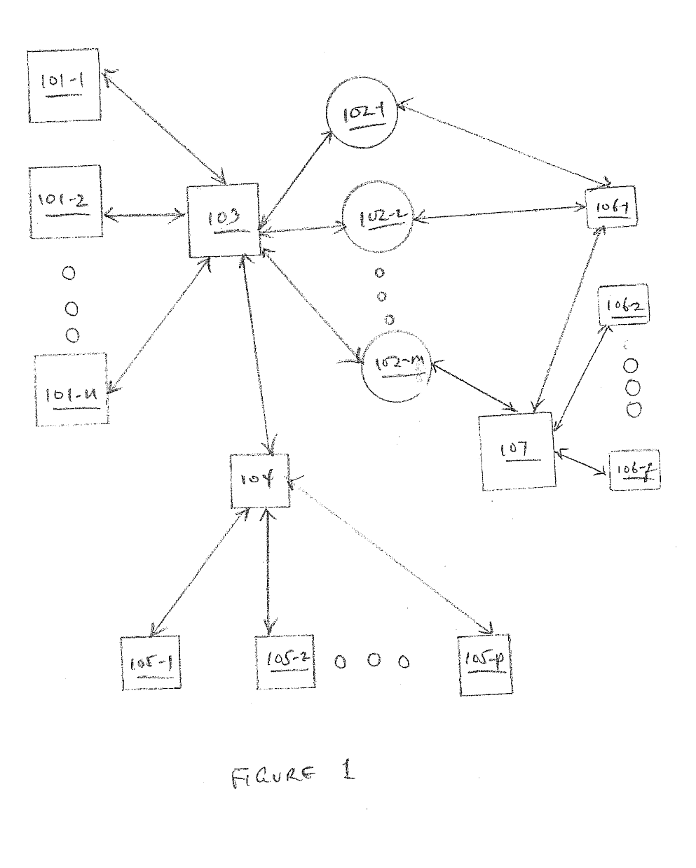

FIG. 1 shows system 100 that includes multiple real time data sources 101-1, 101-2, . . . , 101-n (collectively, “real time data sources 101”) on a data network. Such real time data sources may be, for example, video cameras providing live video streams. Other real time data sources may include thermometers, seismometers, anemometers, barometers, or any other sensors that provide output signal streams representative of the measured quantities. As shown in FIG. 1, real time data sources 101 provide their data streams to one or more servers on the data network, represented by stream server 103. In some applications, where appropriate, stream server 103 also provides control signals to real time data sources 101. For example, in a network of video cameras, in response to user requests, stream server 103 may control the orientation, the field of view and the focus of a video camera providing one of the live video streams, or may start or stop a data stream. Stream server 103 provides the data streams received to various destinations over the data network, such as to users who request to view one or more specified video streams. As shown in FIG. 1, stream server 103 provides selected data streams to one or more user-facing servers on the data network (represented, for example, by web server 104). Web server 104 serves a number of web clients 105-1, 105-2, . . . , 105-p (collectively, “users 105”) over corresponding web interfaces. Some web clients may include video players or web browsers.

As shown in FIG. 1, stream server 103 also provides data streams to be processed by perceptors 102-1, 102-2, . . . , 102-m. A perceptor is a device or process that performs a specific function on one or more data streams received from the real time data sources. Some examples of the specific functions that may be performed by a perceptor include: computing statistical quantities from a data stream over a rolling time window (e.g., an average temperature from a data stream provided by a thermometer), detecting motion from successive video frames in a live video stream, recognizing a specific object from a still picture (e.g., recognizing and reading a vehicle license plate, or recognizing a specific vehicle model), and recognizing the presence or absence of a specific condition (e.g., a door is being left ajar or closed).

A perceptor may perform its function in conjunction with “meta-data.” The term meta-data refers to information regarding the data stream itself. For example, a perceptor may be programmed to operate only at certain times of the day or only after another perceptor detects a predetermined condition. Another example of meta-data is geolocation data indicating the location of the video camera broadcasting the associated live video stream.

Perceptors may be implemented in hardware (e.g., a dedicated circuit board) or in software as processes in a general purpose or customized computer.

Depending on the specific function being performed, a perceptor may use, for example, arithmetic or mathematical techniques (e.g., compiling statistics of wind speeds and directions from a data stream received from an anemometer), speech detection and recognition (e.g., capturing verbal commands from a data stream from a microphone), computer vision techniques (e.g., recognizing a specific object, such as a Q-R code from a still picture frame extracted from a live video stream of a video camera), and character recognition techniques (e.g., reading license plates from a still picture frame extracted from the data stream of live video source). Many of these techniques have been used in other applications and under different implementations. Many such techniques are known to those of ordinary skill in the art. Depending on the function performed by a perceptor, the perceptor may have a data update frequency that is different from those of other perceptors. For example, a perceptor that outputs a temperature range in a temperature-controlled environment (e.g., an incubator in a laboratory) may have an update rate, for example, of every 2 hours. That perceptor may also provide asynchronous updates, such as when an out-of-range temperature is detected.

Perceptors 102-1, 102-2, . . . , 102-m may provide their output data streams in defined formats directly to devices that use their output data, such as applications 106-1, 106-2, . . . , 106-q (collectively, “applications 106”), such as shown in FIG. 1. They may also provide their output data streams to data collection servers (e.g, data collection server 107), which may store and provide, in turn, the collected perceptor data streams to devices that use their output data. As used in this detailed description, the term “application” should be understood to encompass not only software (e.g., an application program), but also hardware devices.

One example of a function perform by an application would be a security device that monitors motion-detecting perceptors associated with a specific group of live video streams. Such an application may provide, for example, an alert response when motion is detected by any of the monitored perceptors. In that application, the alert response may be, for example, sounding an alarm, sending an email or an SMS message, activating additional cameras to record activities in a specific security perimeter in which motion is detected. There are numerous other appropriate responses. Some responses include taking a combination of different actions.

Another example of a function that may be performed by an application may be generation of a traffic condition report. Such an application monitors motion-detecting perceptors associated with a specific group of live video streams provided at various locations along one or more public highways. The application may derive, for example, a traffic condition report based on the speeds of the objects in motion detected by perceptors processing the various live video streams monitored. Perceptors detecting a range of visibility, or other weather conditions, may also be useful in this application, as the traffic condition report derived by the application may include the visibility conditions at the various locations being monitored. Such fog-detecting perceptors may be particularly valuable at locations where fog is a frequent occurrence.

In conjunction with motion-detecting perceptors, object recognition perceptors may be used to perform object tracking using video streams from cameras that are situated to have overlapping, abutting, or proximate views. For example, pattern identification or recognition techniques, that take advantage of estimated object size, shape, color, speed, travel direction, other objects (e.g., traffic lights along a public thoroughfare), and contextual information, may be applied, for example, to identify a vehicle in motion. Object recognition perceptors may be coupled with additional manually procured analysis, feedback, or intervention to enhance accuracy in recognition. Once the object to be tracked is identified in one video stream, the object may be tracked across video streams as the object travels from the view of one camera to the view of the next camera along its direction of travel.

Although shown in FIG. 1 as receiving data streams from stream server 103, some perceptors may actually be sources of data streams provided to stream server 103. For example, a perceptor may be integrated with a security camera to detect motion in the video frames being captured. In that application, the perceptor may activate output of a live video stream from the security camera to stream server 103 only when motion is detected.

Another example of a perceptor provided at a data source is a lighting condition sensor associated with a video camera. In that application, the perceptor detects the local lighting condition to update recommended sensitivity settings in the video camera required to provide a predetermined image quality under the detected local lighting condition. The sensitivity settings output by the perceptor may be forwarded, for example, to one of applications 106, which may, in turn, direct the associated video camera to be reconfigured to the recommended sensitivity settings, when necessary.

In some applications, the specific function performed by a perceptor may require data input by a human being. For example, in one application, human users (e.g., users 105) may each be assigned the task of reviewing one or more live video streams for the presence of a specific object (e.g., the presence of a vehicle of a particular vehicle model) and providing feedback signals to an application over the data network when the presence of the specific object is spotted in the data streams being reviewed. An application may then track the monitored object from the fed back signals received from the reporting human users, based on the locations associated with the respective data sources of the live video streams. In another application, each human user may be assigned the task of reviewing a live video stream for the occurrence of a certain class of events (e.g., certain spectacular plays or maneuvers in a sporting event). In that application, the human user provides a data input to an application with a web interface. The data input from the human user is provided over the data network to a web server, which causes a feedback signal to be sent to the output data of the perceptor. An application may tally the frequency and the number of the feedback signals received to generate statistics that are indicative of viewer interest in the video stream. Such viewer interest may suggest, for example, a likelihood of subsequent viewings of the video stream. Such information may be useful information to advertisers, for example.

Alternatively, a perceptor may provide a derivative data stream to one or more other perceptors. (In this detailed description, a derivative data stream is a data stream that results from a perceptor processing either a raw sensor data stream, or another derivative data stream.) Therefore, some perceptors may receive both raw data streams (i.e., data streams from primary data sources) from a stream server and derivative data streams from other perceptors.

One application of such a perceptor is “stream-tagging,” in which the derivative data stream provided by the perceptor depends upon meta-data that is related to the data stream from which it is derived (i.e., the “source data stream”). For example, the derivative data stream may track events detected in the source data stream (e.g., a perceptor may detect the opening of the door to a business within the view of its source data stream). In another example, the derivative data stream may include viewership characteristics such as viewer counts, or viewing trends (e.g., changes in the number of views simultaneous accessing the source data stream). In another application, a perceptor may tag a video stream based on reactions collected from viewers of the video stream. A content provider may ask viewers of a specific video stream to provide feedback on specific scenes or event occurrences that they see in the video streams. As another example, viewers watching a video stream of a politician delivering a campaign speech may be asked to react by pressing a button indicating a degree of approval or disapproval. A perceptor may tag the video stream contemporaneously with the collected approval rating, along with identification information of the viewer, which would then allow another perceptor having demographic information of the viewers who responded to tag the video stream in yet another derivative stream with such demographic information. An application may then compute metrics that indicate how voters of different demographic backgrounds may respond to the specific issues addressed in the speech, and other statistics.

In all such examples, the derivative data stream is permanently synchronized back to the source data stream by use of a timestamp common to both data sources. This synchronization provides the ability for the derivative data to be further processed by another perceptor or application for subsequent data analysis or replay, as may be requested by viewers. For example, it may be possible to include viewer demographic information as part of the overall application at a later time when such demographic information becomes available. An application may perform the subsequent analysis to help the content provider to plan future offerings of similar content.

In another application, perceptors may be each trained to detect and to tag occurrences of different events on the same data stream. The results in the derivative streams may be processed by another perceptor to discover hidden correlations or relationships in the different events. Such information may be used by another perceptor to predict future occurrences and to appropriately send alerts when the predicted event occurs. Clearly, such an application, and other similar applications, would have great value in commercial and other contexts. In this manner, the derivative streams that can be created by tagging events on a raw data stream would greatly enhance the utility or other values of the raw data stream.

Servers, such as stream server 103, web server 104, and data collection server 107, allow the connectivities or the configurations of the elements in system 100 to be dynamically varied. For example, any of applications 106 may connect dynamically to any of perceptors 102 through a request to server 107. Similarly, any of applications 106 may reconfigure any of perceptors 102-1, 102-2, . . . , 102-m for association with any of data sources 101, through a request to stream server 103. Similarly, any of users 105 may effectuate changes in the connectivities or configurations of applications 106, perceptors 102 and real time data sources 101 through applications that cause requests to be made to web server 104, stream server 103 and data collection server 107. In one embodiment the applications may communicate with a perceptor using an application program interface (API).

In one embodiment, a service provider provides an application that allows a user (e.g., one of users 105) to select one or more pre-configured perceptors to operate on one of real time data streams, also selectable by the user using the application. The user also selects one or more applications to process the output data streams of the selected perceptors. The applications may be pre-configured or may be configured by the user using available scripting or programming techniques. In this manner, a user may harvest the significant value in the real time data streams in a convenient way.

The above detailed description is provided to illustrate specific embodiments of the present invention and is not intended to be limiting. Numerous variations and modifications within the scope of the present invention are possible. The present invention is set forth in the accompanying claims.

We claim:

1. A distributed system in a data network for processing real time data streams from a plurality of data sources, comprising:
a plurality of perceptors accessible over the data network each being configured to perform a specific task, each perceptor receiving one or more of the real time data streams and providing an output data stream indicative of the results of performing the specific task;
a plurality of applications accessible over the data network each being configured to receive one or more of the output data streams of the perceptors and each being configured to provide a response based on analyzing the received output data streams of the perceptors; and
a stream server accessible over the data network, the stream server receiving the real time data streams and being configured to provide any of the received real time data streams to any of the perceptors.

2. The distributed system of claim 1, further comprising a data collection server accessible over the data network, the data collection server being configured to provide the output data stream of any of the perceptors to any of the applications.

3. The distributed system of claim 1, wherein a selected one of the output data streams of the perceptors is provided to the stream server as one of the real time data streams.

4. The distributed system of claim 1, further comprising a web server accessible over data network by clients each using a corresponding web interface, the web server receiving one or more of the real time data streams and providing each client one or more of the real time data streams.

5. The distributed system of claim 4, wherein each client is associated with an application that communicates with one or more of the perceptors or one or more of the applications using an application program interface.

6. The distributed system of claim 5, wherein one of the clients receives an input from a human user that, based on the input, causes a feedback signal to be sent to one of the perceptors.

7. The distributed system of claim 1, wherein the data sources comprise cameras providing live video streams.

8. The distributed system of claim 7, wherein one or more of the perceptors apply to the received video streams computer vision techniques, so as to recognize a specific object captured in a frame of the video streams.

9. The distributed system of claim 8, wherein one or more of the perceptors apply to one or more of the received video streams motion detection techniques, so as to recognize motion of one or more objects captured in the frames of the video streams.

10. The distributed system of claim 9, wherein an application receives output data streams from two or more video streams from the perceptors, the application tracking the recognized motion of an object captured across video streams by following the appearances of the images of the object in the video streams.

11. The distributed system of claim 1, wherein one or more of the perceptors apply to the received real time data streams speech recognition techniques, the received real time data streams comprising sound captured by a microphone, so as to recognize a verbal command.

12. The distributed system of claim 1, wherein one or more of the perceptors apply to the received real time data streams pattern recognition techniques, the real time data streams comprising a plurality of still images, so as to recognize an embedded code in one of the still images.

13. The distributed system of claim 1, wherein one or more of the perceptors apply to the received real time data streams character recognition techniques, the real time data streams comprising a plurality of still images, so as to recognize characters embedded in one of the still images.

14. The distributed system of claim 1, wherein one or more of the perceptors compute statistics from the received real time data streams.

15. The distributed system of claim 1, wherein the response comprises sending an electronic message to inform a user of an exception condition.

16. The distributed system of claim 1, wherein the response comprises causing a corrective action to be performed at the data sources.

17. The distributed system of claim 1, wherein a selected one of the perceptors receive the output data stream of a second selected one of the perceptors.

18. The distributed system of claim 1, wherein a selected one of the perceptors provides data in its output data stream to mark occurrences of a selected event in the real time data stream it receives.

19. The distributed system of claim 18, wherein the data marking occurrences of the selected event comprise timestamps.

20. The distributed system of claim 18, wherein the data marking occurrences of the selected event comprise user feedback data regarding the marked events.

21. The distributed system of claim 20, wherein the user feedback data comprise users' reactions to the marked events.

22. The distributed system of claim 21, wherein a second selected one of the perceptors provides demographic data concerning users providing the user feedback data.

23. The distributed system of claim 21, wherein a selected one of the applications receives the output data streams of the first and second selected perceptors to analyze the user feedback data in conjunction with the marked event.

24. In a distributed system in a data network, a method for processing real time data streams from a plurality of data sources, comprising:
Configuring each of a plurality of perceptors accessible over the data network to perform a specific task, each perceptor receiving one or more of the real time data streams and providing an output data stream indicative of the results of performing the specific task;
configuring each of a plurality of applications accessible over the data network to receive one or more of the output data streams of the perceptors and to provide a response based on analyzing the received output data streams of the perceptors; and
receiving the real time data streams in a stream server accessible over the data network, the stream server being configured to provide any of the received real time data streams to any of the perceptors.

25. The method of claim 24, further comprising configuring a data collection server accessible over the data network to provide the output data stream of any of the perceptors to any of the applications.

26. The method of claim 24, wherein a selected one of the output data streams of the perceptors is provided to the stream server as one of the real time data streams.

27. The method of claim 24, further comprising configuring a web server in the data network to be accessed by clients each using a corresponding web interface, the web server receiving one or more of the real time data streams and providing each client one or more of the real time data streams.

28. The method of claim 24, wherein each client is associated with an application that communicates with one or more of the perceptors or one or more of the applications using an application program interface.

29. The method of claim 28, wherein one of the clients receives an input from a human user that, based on the input, causes a feedback signal to be sent to one of the perceptors.

30. The method of claim 24, wherein the data sources comprise cameras providing live video streams.

31. The method of claim 30, wherein one or more of the perceptors apply to the received video streams computer vision techniques, so as to recognize a specific object captured in a frame of the video streams.

32. The method of claim 31, wherein an application receives output data streams from two or more video streams from the perceptors, the application tracking the recognized motion of an object captured across video streams by following the appearances of the images of the object in the video streams.

33. The method of claim 30, wherein one or more of the perceptors apply to one or more of the received video streams motion detection techniques, so as to recognize motion of one or more objects captured in the frames of the video streams.

34. The method of claim 24, wherein one or more of the perceptors apply to the received real time data streams speech recognition techniques, the received real time data streams comprising sound captured by a microphone, so as to recognize a verbal command.

35. The method of claim 24, wherein one or more of the perceptors apply to the received real time data streams pattern recognition techniques, the real time data streams comprising a plurality of still images, so as to recognize an embedded code in one of the still images.

36. The method of claim 24, wherein one or more of the perceptors apply to the received real time data streams character recognition techniques, the real time data streams comprising a plurality of still images, so as to recognize characters embedded in one of the still images.

37. The method of claim 24, wherein one or more of the perceptors compute statistics from the received real time data streams.

38. The method of claim 24, wherein the response comprises sending an electronic message to inform a user of an exception condition.

39. The method of claim 24, wherein the response comprises causing a corrective action to be performed at the data sources.

40. The method of claim 24, wherein a selected one of the perceptors receive the output data stream of a second selected one of the perceptors.

41. The method of claim 24, wherein a selected one of the perceptors provides data in its output data stream to mark occurrences of a selected event in the real time data stream it receives.

42. The method of claim 41, wherein the data marking occurrences of the selected event comprise timestamps.

43. The method claim 41, wherein the data marking occurrences of the selected event comprise user feedback data regarding the marked events.

44. The method of claim 43, wherein the user feedback data comprise users' reactions to the marked events.

45. The method system of claim 44, wherein a second selected one of the perceptors provides demographic data concerning users providing the user feedback data.

46. The method of claim 44, wherein a selected one of the applications receives the output data streams of the first and second selected perceptors to analyze the user feedback data in conjunction with the marked event.
